(19) United States
(12) Patent Application Publication
(10) Pub. No.: US 2025/0278575 A1
(43) Pub. Date: Sep. 4, 2025

(54) USING NEGATIVE FEEDBACK LEARNING ON A LANGUAGE MODEL-BASED NETWORK TROUBLESHOOTING AGENT

(71) Applicant: Cisco Technology, Inc., San Jose, CA (US)

(72) Inventors: Jean-Philippe Vasseur, Combloux (FR); Grégory Mermoud, Venthône (CH); Pierre-André Savalle, Rueil-Malmaison (FR); Eduard Schornig, Haarlem (NL); Grégoire Magendie, Lamorlaye (FR)

(73) Assignee: Cisco Technology, Inc., San Jose, CA (US)

(21) Appl. No.: 18/592,851

(22) Filed: Mar. 1, 2024

(51) Int. Cl. G06F 40/40; G06N 3/0455; G06N 3/096; H04L 41/0686; H04L 41/16

(52) U.S. Cl. CPC G06F 40/40; G06N 3/0455; G06N 3/096; H04L 41/0686; H04L 41/16

(57) ABSTRACT

In one implementation, a device obtains an indication of a failure by a language model-based agent for a computer network to perform a first task requested by a first prompt. The device determines a feedback metric that quantifies how critical the failure is. The device identifies a subsequent prompt for the language model-based agent to perform a new task of a similar type as the first task. The device adjusts, based on the feedback metric, the subsequent prompt to avoid the language model-based agent failing the new task.

### TECHNICAL FIELD

The present disclosure relates generally to using negative feedback learning on a language model-based network troubleshooting agent.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

In general, self-healing networks refer to the ability of a network to close the loop whereby automation actions are triggered when specific event takes place (e.g., reporting of an issue, detection of an issue, etc.). However, LLMs have not been used to trigger actions in self-healing networks, due to a myriad of challenges associated with their use for network monitoring and control. First, an agent flow to answer a question may require multiple steps, each of which individually can take some time. Consequently, there may be a noticeable delay in returning an answer to the original question (e.g., on the order of minutes), which can be frustrating to users. In addition, LLMs can also make mistakes which may not be apparent to a user and are difficult to identify. Such mistakes, though, can be valuable forms of negative feedback for purposes of improving the LLM over time, so that the LLM can avoid making the same mistakes again and again.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIG. 4 illustrates an example software defined network (SDN) implementation;

FIG. 5 illustrates an example architecture for using a large language model (LLM)-based agent to provide self-healing capabilities to a network;

FIG. 6 illustrates the operation of an LLM-based agent in a self-healing network;

FIG. 7 illustrates an example architecture for a failure analysis agent;

FIG. 8 illustrates an example showing the evaluation of an answer by an LLM-based network troubleshooting and monitoring agents; and

FIG. 9 illustrates an example simplified procedure for using negative feedback learning on a language model-based network troubleshooting agent.

### DESCRIPTION OF EXAMPLE IMPLEMENTATIONS

### Overview

According to one or more implementations of the disclosure, a device obtains an indication of a failure by a language model-based agent for a computer network to perform a first task requested by a first prompt. The device determines a feedback metric that quantifies how critical the failure is. The device identifies a subsequent prompt for the language model-based agent to perform a new task of a similar type as the first task. The device adjusts, based on the feedback metric, the subsequent prompt to avoid the language model-based agent failing the new task.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

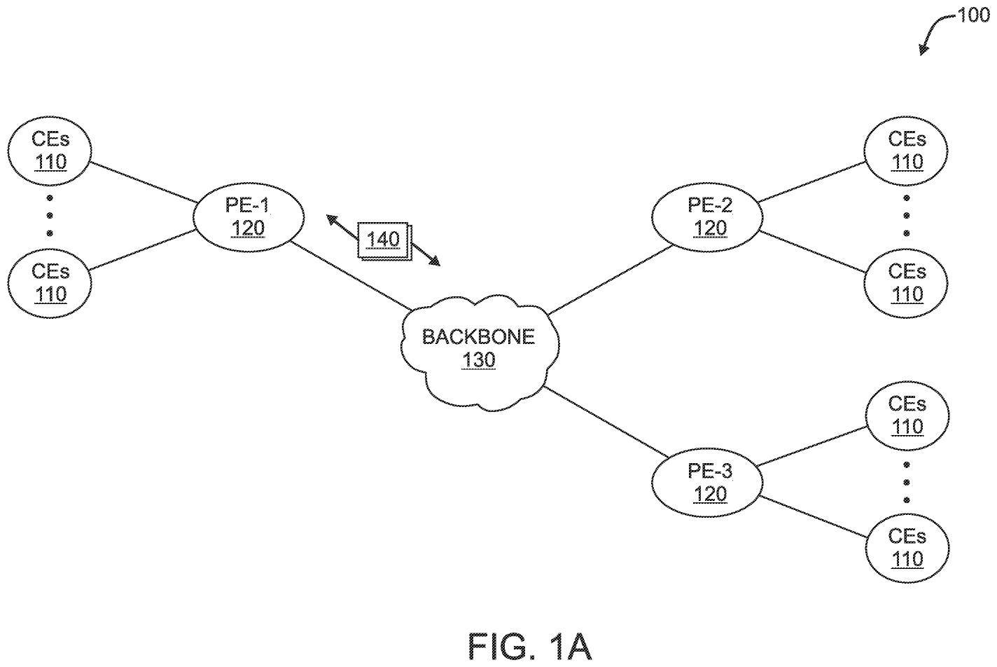

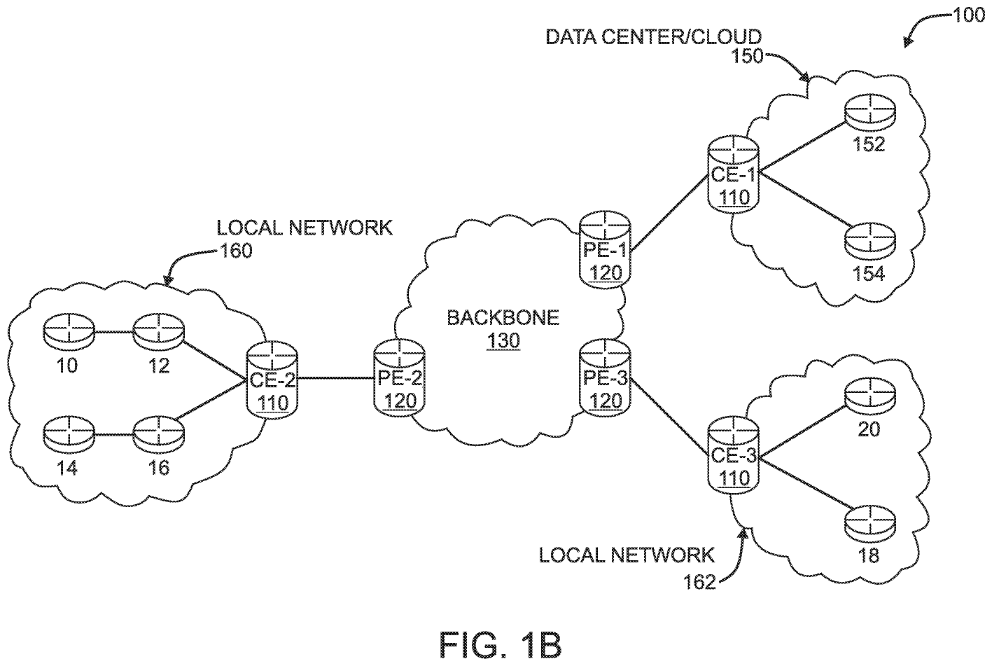

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

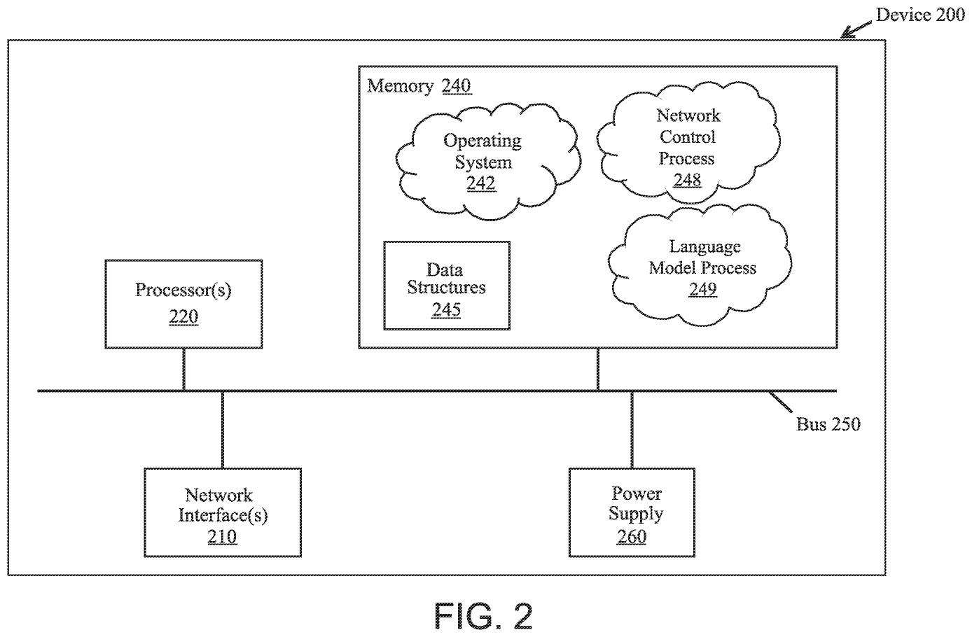

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a network control process 248 and/or a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In some instances, network control process 248 may include computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, network control process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, network control process 248 and/or language model process 249 may include computer executable instructions that, when executed by processor(s) 220, cause device 200 to perform the techniques described herein. To do so, in some implementations, network control process 248 and/or language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, network control process 248 and/or language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that network control process 248 and/or language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, network control process 248 and/or language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, network control process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

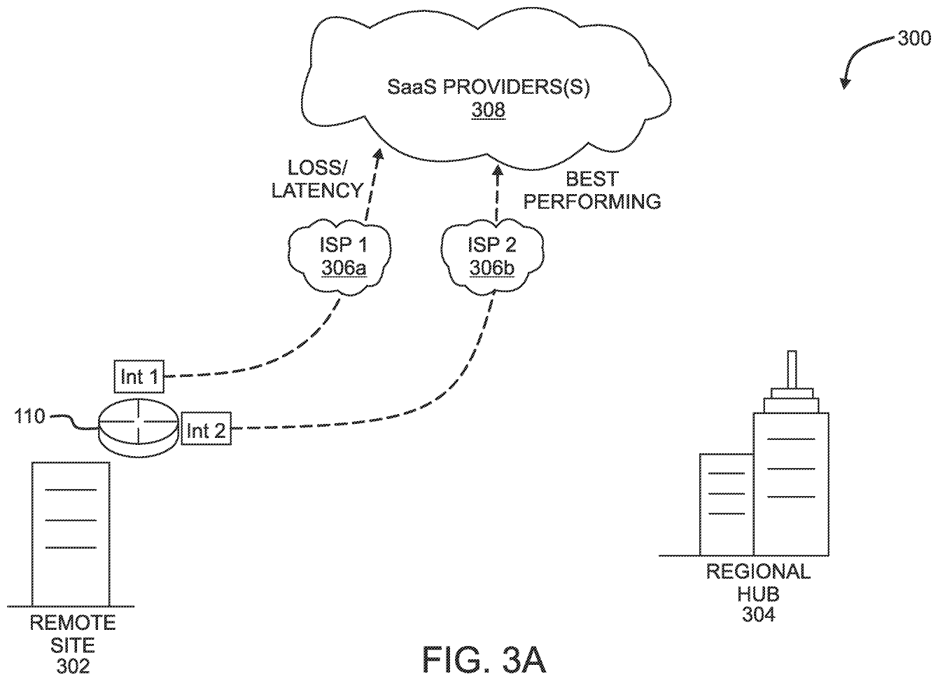

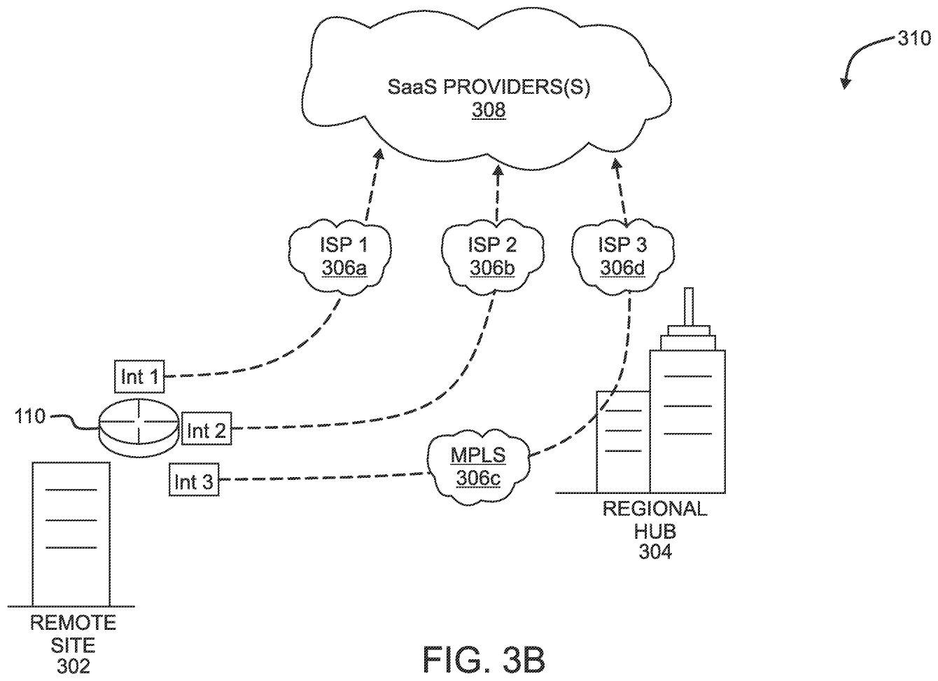

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

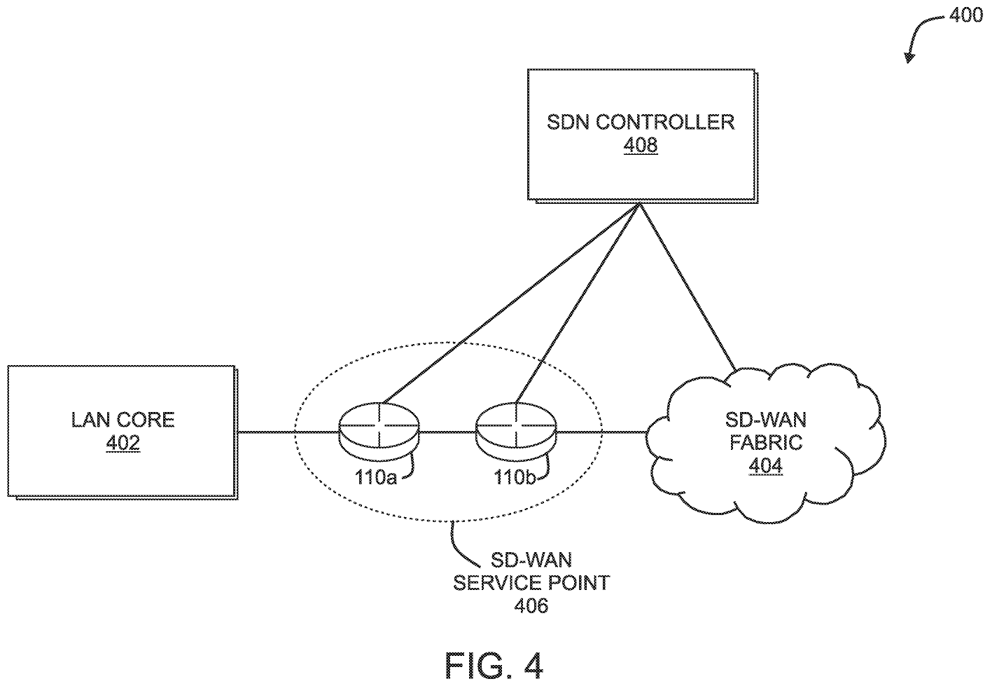

FIG. 4 illustrates an example SDN implementation 400, according to various implementations. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service (e.g., through execution of network control process 248), typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various implementations, SDN controller 408 may employ application aware routing, which refers to the ability to route traffic so as to satisfy the requirements of the application, as opposed to exclusively relying on the (constrained) shortest path to reach a destination IP address. For instance, SDN controller 408 may make use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, SDN controller 408 may compute a variety of models to understand application requirements, and predictably route traffic over private networks and/or the Internet, thus optimizing the application experience while drastically reducing SLA failures and downtimes.

In other words, SDN controller 408 may first predict SLA violations in the network that could affect the QoE of an application (e.g., due to spikes of packet loss or delay, sudden decreases in bandwidth, etc.). In other words, SDN controller 408 may use SLA violations as a proxy for actual QoE information (e.g., ratings by users of an online application regarding their perception of the application), unless such QoE information is available from the provider of the online application. In turn, SDN controller 408 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one implementation. In general, routing configuration changes are also referred to herein as routing “patches,” which are typically temporary in nature (e.g., active for a specified period of time) and may also be application-specific (e.g., for traffic of one or more specified applications).

As noted above, the recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc.

In the specific context of computer networks, though, network troubleshooting and monitoring are traditionally complex tasks that rely on engineers analyzing telemetry data, configurations, logs, and events across a diverse array of network devices encompassing access points, firewalls, routers, and switches managed by various types of network controllers (e.g., SD-WAN, DNAC, ACI, etc.). Moreover, network issues can manifest in various forms, stemming from a multitude of factors, each with its own level of complexity.

The introduction of plugins is a major development that enables LLM-based agents to interact with external systems and empower new domain-specific use cases. In the context of communication networks, the utilization of plugins allows LLMs to engage with documentation repositories, tap into knowledge bases, and interface with live network controllers and devices potentially opening the path to LLMs undertaking more complex tasks such as on-demand troubleshooting, device configuration, and performance monitoring. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, building a user-facing product from an LLM-based agent can be difficult for reasons such as the following:
An agent flow to answer a question may require multiple steps, each of which can take some time, individually. Consequently, the system may take a noticeable amount of time to provide an answer to the original question (e.g., on the order of minutes), which can be frustrating to users.
LLMs can make mistakes which may not be apparent to a user. For example, consider the case of an LLM that can generate code that calls an API to list network devices but somehow provides an incorrect filter argument to the API. When the API returns an empty result set, a user may interpret this result as meaning that no devices match their desired criteria while, in fact, the system simply called the API incorrectly. These issues can be hard to avoid due to the opaque and non-deterministic nature of LLMs, and users may quickly lose confidence in the system when faced with such issues.
Although LLMs can provide an alternative user experience by allowing a user to ask questions about a system using natural language, users often have years of familiarity with traditional web or application user interfaces. A chatbot can feel like a disconnected experience from those user interfaces, which can also be frustrating to users.

In general, self-healing networks, also sometimes called “autonomous networks” or “self-driving networks,” refers to the ability of a network to close the loop whereby automation actions are triggered when specific event takes place (e.g., reporting of an issue, detection of an issue, etc.). However, for the reasons above, LLMs have not been used to trigger actions in self-healing networks, due to the myriad of challenges associated with their use for network monitoring and control.

### ——Using an LLM-Based Agent to Provide Self-Healing Capabilities to a Network——

The techniques herein introduce an LLM-based troubleshooting and monitoring agent that can be used to both troubleshoot an issue and trigger a set of actions in order to solve the issue. In some implementations, several conditions could be met for an issue to be eligible to self-healing, such as the criticality of the issues (determined by the volume of request sent to a bot for that issue). Various mechanisms are then used to determine whether the set of actions led to the resolution of the issue. Successful resolutions are then used to record successful troubleshooting trajectories and thus improve the training of the agent.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein, such as in conjunction with network control process 248.

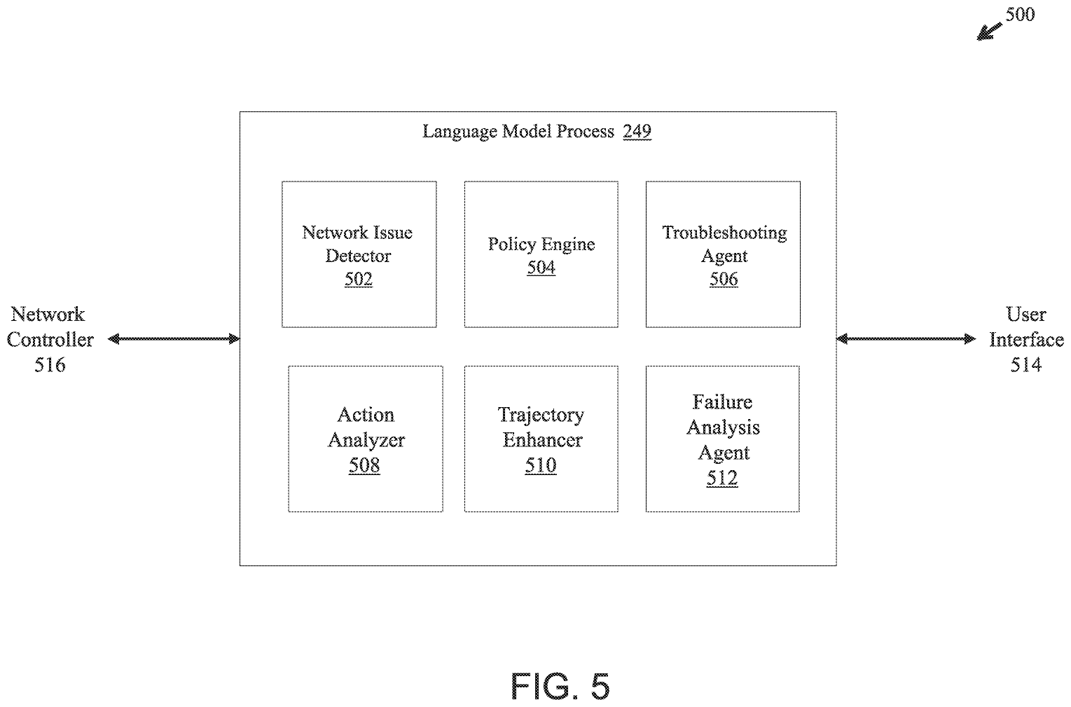

Operationally, FIG. 5 illustrates an example architecture 500 for using a large language model (LLM)-based agent to provide self-healing capabilities to a network, according to various implementations. At the core of architecture 500 is language model process 249, which may be executed by a controller for a network or another device in communication therewith. For instance, language model process 249 may be executed by a controller for a network (e.g., SDN controller 408 in FIG. 4, a network controller in a different type of network, etc.), a particular networking device in the network (e.g., a router, a firewall, etc.), another device or service in communication therewith, or the like. For instance, as shown, language model process 249 may interface with a network controller 516, either locally or via a network, such as via one or more application programming interfaces (APIs), etc.

As shown, language model process 249 may include any or all of the following components: a network issue detector 502, a policy engine 504, a troubleshooting agent 506, an action analyzer 508, a trajectory enhancer 510, and/or a failure analysis agent 512. As would be appreciated, the functionalities of these components may be combined or omitted, as desired. In addition, these components may be implemented on a singular device or in a distributed manner, in which case the combination of executing devices can be viewed as their own singular device for purposes of executing language model process 249.

During execution, network issue detector 502 may detect an issue in a network and assess its criticality. To do so, network issue detector 502 may employ any number of modes for the issue detection. In one case, network issue detector 502 may explicitly list the set of issues eligible for self-healing functionality (e.g., detection of a link/router down, congestion thresholds for a given link layer, trigger of a recovery mechanism such as IGP/FRR, automated network tests or probes failing). In another case, network issue detector 502 may detect an issue based on information from a (troubleshooting) bot receiving requests from a set of users, in which case the issue can be created on-the-fly, if the number/rate of requests related to (a specific type of) issue exceeds a given threshold (e.g., via a chatbot).

Once network issue detector 502 has detected an issue I, it may then determine the criticality of that issue. To that end, one option may consist in checking the number of potential users who raised a similar issue that share the same root cause according to the root causing process initiated by troubleshooting agent 506, as described below, or its LLM may also be used to determine whether the issues raised by the users have a common root cause. In other cases, an LLM may determine criticality based on the number of impacted systems or applications or the volume of affected network traffic.

Policy engine 504 is used to configure which issues identified by network issue detector 502 are eligible for LLM-based self-healing capabilities. Indeed, despite the potential power of self-healing networks, the effective use of dynamic closed-loop control is subject to debate. Consequently, some administrators are ready to adopt closed-loop control with no human in the loop wherever and whenever possible, whereas others do mandate the presence of a human to perform any action in the network, sometimes such decisions are even driven by regulations. To this end, policy engine 504 allows a network administrator to specify policies to selectively enable or disable the self-healing capabilities of the system with respect to certain types of issues.

For example, a network administrator may specify via policy engine 504 (e.g., using a user interface 514) the set of applications eligible to for self-healing resolution and/or whether a minimum number of users per application type is required to automatically trigger closed-loop control according to troubleshooting agent 506. Further constrains can be defined for governing in which parts of the network (specific sites) or on which types of devices troubleshooting agent 506 is allowed is allowed to attempt remediation actions. For example, a network administrator may allow troubleshooting agent 506 to initiate the reboot of a wireless access point, while restricting the same action on a core router or central firewall.

According to various implementations, troubleshooting agent 506 may leverage one or more LLMs to troubleshoot an issue identified by policy engine 504, find the actual root cause for the issue, and/or suggest a set of one or more actions to fix the issue. Let ai denote an action used for troubleshooting an issue I and let Ai denote an action (configuration change) on the network (closed-loop control). The set of actions Ai required to solve the issue I may be determined on-the-fly by an LLM, statically determined according to a cookbook for each trajectory made of a set of action ai, or the like. For example, a static cookbook may be used to map a specific ak to set of actions Ak,l. Consider the action ak=“Check the priority queue length of a router,” a static set of action ak,l may be used to trigger a set of l action on the network (e.g., “Change the weight of the priority queue,” “Modify the WRED parameter for the high priority queue”). In another implementation, the system may discover the set of required actions related to a given root cause identified thanks to a set of action ai, using reinforcement learning or another suitable approach.

If the root cause identified for issue I is eligible for self-healing action (according to policy engine 504), troubleshooting agent 506 may perform any or all of the following:
Troubleshooting agent 506 retrieves the set of action Ai for the root cause of issue I after activating a timer T (max time to solve the issue)
Troubleshooting agent 506 may also employ various optimization criterion may be used for solving a given task T. For instance, troubleshooting agent 506 may solve some tasks with objective metrics such as reducing the processing time or improve accuracy even at the risk of involving more steps and tokens (cost). In the context of the techniques herein, the issue criticality from network issue detector 502 may also drive the optimization criteria (time versus reliability versus cost). In one implementation, the optimization criteria may be unique and decided according to policy and criticality. In another implementation, troubleshooting agent 506 may trigger multiple actions in parallel, each with different optimization criterion. For example, for a given issue I, troubleshooting agent 506 may send a request to a first LLM with a first criteria (e.g., solve as quickly as possible, optimizing time) and send the same request to a second LLM with different optimization criteria (e.g., efficiency). In such a case, troubleshooting agent 506 may use the reply to the first request (set of resolution action Ai) to quickly fix the network, followed by using the second set of actions to optimize the resolution of the issue. Note that both requests may not overlap in terms of closed-loop actions, as well.

Action analyzer 508 may assess whether the set of actions triggered by troubleshooting agent 506 have actually solved the issue. To that end several approaches may be used:
The LLM may itself ask to the users who had originally expressed some concerns whether the issue has been remediated.
The agent may check the various set of actions ai along the debugging trajectories whether the conditions that were used to identify the issues have been cleared. For example, back to the previous example, the system may check the high priority queue length and determine whether the action (change the weight) has solved the issue.

In some implementations, trajectory enhancer 510 is used to enhance the set of successful trajectories. As would be appreciated, troubleshooting agent 506 represents a complex troubleshooting and monitoring mechanism that may be based on one or more LLMs, a local database, and other components. On receiving a question, troubleshooting agent 506 may form a prompt after retrieving a set of “information” from a local database and triggers a set of actions ai (i.e., code snippet used to retrieve information from APIs, etc.) until an answer to the question is provided.

In this context, a “trajectory” refers to a set of successive actions ai triggered by troubleshooting agent 506 according to the LLM input. In some instances, trajectory enhancer 510 may use the trajectories to train one or more of the LLMs to perform similar troubleshooting tasks, stored as recipes (set of successful actions, etc.). For instance, action analyzer 508 may flag an action as successful if the answer from troubleshooting agent 506 satisfies a set of characteristics for a given (manual crafted) scenario.

In some instances, trajectory enhancer 510 may also function as a “troublemaker,” generating issues and then requesting that troubleshooting agent 506 solve them, knowing the answer to the question, beforehand. Thanks to the techniques herein, knowing whether an issue has been solved can be told by determining whether the issue has been solved (an even stronger assumption than in the case of finding a known root cause). Thus, each time the issue is solved by triggering one of more action Ai that solves the issue I, the corresponding trajectory is marked as successful and the list of action ai can be added to the database of successful trajectories.

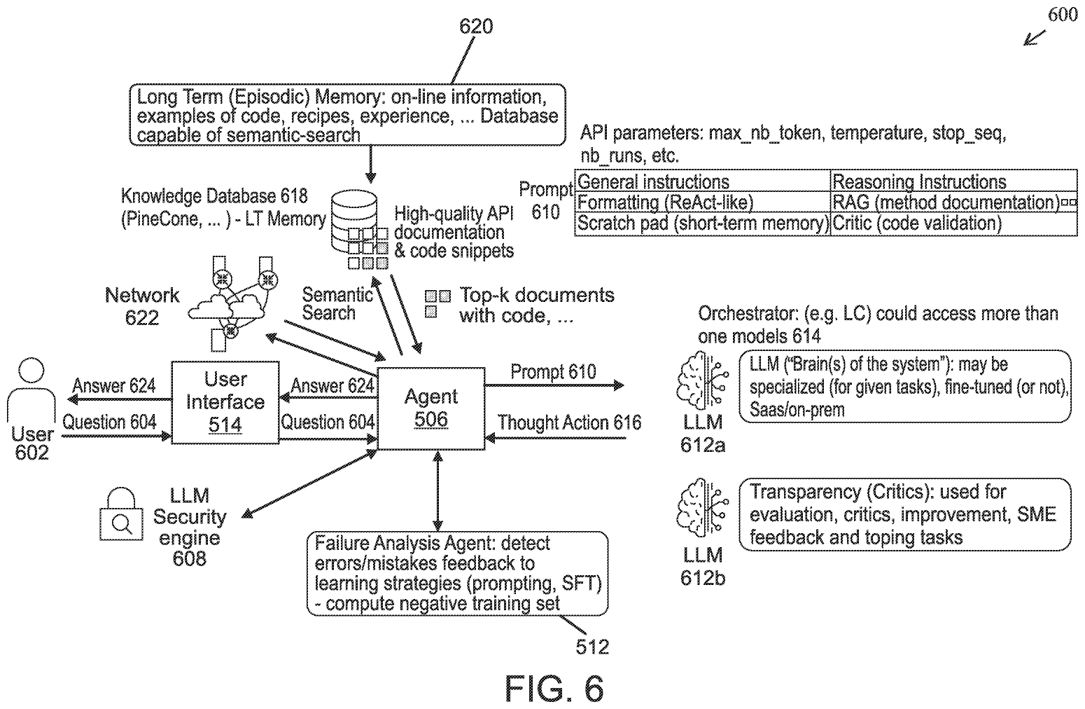

FIG. 6 illustrates an example 600 showing the operation of troubleshooting agent 506 performing self-healing actions in a network 622, according to various implementations. As shown, troubleshooting agent 506 may interact with one or more LLMs 612, such as LLMs 612a-612b shown, to perform self-healing actions in a network 622. These LLMs may be integrated directly into troubleshooting agent 506 or accessed by troubleshooting agent 506 remotely, such as via an API. In some implementations, each of these LLMs may have different capabilities, as well. For instance, LLM 612a may a 0-shot or model trained using Low-Rank Adaptation of LLMs (LoRA), whereas LLM 612b may be a fine-tuned model (e.g., using T5 with LoRA, knowledge distillation, etc.) with decoding lop access for constrained prompting. In some instances, troubleshooting agent 506 may also leverage an intermediary orchestrator 614 that can access one or more of the LLMs, such as LLM 612a and LLM 612b.

Assume now that a user 602 enters a question 604 via user interface 514 regarding network 622. Note that while such input typically takes the form of a question, mere statements such as “my network connection is slow, etc.” are also equally possible inputs. In turn, troubleshooting agent 506 may seek to answer question 604 by interacting with network 622, interacting with a knowledge database 618 populated by a long term (episodic) memory 620 (e.g., by performing a semantic search for API formats, code snippets, recipes, sample use cases, or the like), and/or by issuing a prompt 610 for input to any of LLMs 612. Note that prompt 610 may also indicate general instructions and/or reasoning instructions, to obtain information regarding an action 616. In some instances, an LLM security engine 608 may also oversee the actions of troubleshooting agent 506, to prevent conditions such as prompt injection attacks, etc.

In some cases, troubleshooting agent 506 may also implement action 616 in network 622. For instance, troubleshooting agent 506 may send a command to a network controller of network 622 (e.g., via an API) to reconfigure the network to address any issues. In turn, troubleshooting agent 506 may provide an answer 624 back to user interface 514 to answer question 604 (e.g., “your connection was slow because of a misconfiguration-please let us know if the issue has been resolved,” etc.).

### ——Using Negative Feedback Learning on a Language Model-Based Network Troubleshooting Agent——

As would be appreciated, most, if not all of, machine learning/artificial intelligence approaches consist of showing data reflecting the task an algorithm should learn. Consider the case of a classifier with n-number of categories: the training set would consist in showing of a large number of samples (vectors) with k-dimensions referred to as input features along each category. Such data is then used to train a machine learning model to perform classification.

In the world of LLMs, the idea of N-shot learning consists of showing N examples that “work” in the prompt sent to the model (in context learning) and it has been shown that such an approach greatly improves the performance of the LLM. Here is a simple 3-shot learning example (generated by GPT4):

### Example 1

Problem: “A farmer has 17 sheep and all but 9 die. How many are left?”
Solution: “9 sheep are left. The phrase ‘all but 9 die’ means every sheep except for 9 died.”

### Example 2

Problem: “If it takes 5 machines 5 minutes to make 5 widgets, how long would it take 100 machines to make 100 widgets?”
Solution: “5 minutes. Each machine takes 5 minutes to make one widget, so regardless of how many machines or widgets there are, it will take 5 minutes for each machine to make a widget.”

### Example 3

Problem: “In a certain family, each son has as many brothers as sisters, but each daughter has twice as many brothers as sisters. How many sons and daughters are there in the family?”
Solution: “There are four sons and three daughters. Each son has 3 brothers and 3 sisters, and each daughter has 4 brothers and 2 sisters.”

### New Problem to Solve:

Problem: “A container has 100 liters of a mixture of milk and water in the ratio of 7:3. How much water should be added to the mixture so that the ratio of milk to water becomes 3:7?”
Expected model response: “Initially, there are 70 liters of milk and 30 liters of water. To make the ratio of milk to water 3:7, let the amount of water to be added be x liters. The new quantity of water will be (30+x) liters, and milk remains 70 liters. The ratio of milk to water becomes 70:(30+x). For this to be equal to 3:7, 70/(30+x)=3/7. Solving this equation, we find x=110 liters. Therefore, 110 liters of water should be added.

In the process of learning, providing examples is also a very powerful technique to learn. Even more efficient is the ability to learn from mistakes. Indeed, learning from mistakes is likely to be quite efficient.

According to further aspects, the techniques herein augment the network self-healing capabilities described above by using negative feedback learning to improve its LLM-based troubleshooting agent over time. More specifically, the system advantageously makes use of past failed tasks, assesses the consequences of such failures, computes a negative signal strength reflecting the severity of the failure that is then sent to several components of the architecture to tune the model appropriately (and potential fix the knowledge that led to the failures or even unlearn), and/or adjust the prompting strategies in order to provide examples of incorrect thoughts.

Specifically, according to various implementations, a device obtains an indication of a failure by a language model-based agent for a computer network to perform a first task requested by a first prompt. The device determines a feedback metric that quantifies how critical the failure is. The device identifies a subsequent prompt for the language model-based agent to perform a new task of a similar type as the first task. The device adjusts, based on the feedback metric, the subsequent prompt to avoid the language model-based agent failing the new task.

Referring again to FIG. 6, failure analysis agent 512 may be responsible for several important tasks of negative learning, such as any or all of the following:
Determining the list of tasks that failed and are candidates for negative learning;
Evaluating the consequences of a task that failed and is a candidate for negative learning and evaluate the strength of the negative signal (i.e., signal sent to other components that reflect the consequences of the failed task);
Determining the most appropriate strategy to tune the model to mitigate the risk of such a failure happening again;
Performing prompt adjustment about “negative” examples to be added to the prompt for similar tasks; and/or
Evaluating the performance of negative learning and adjusting the strategy, accordingly.

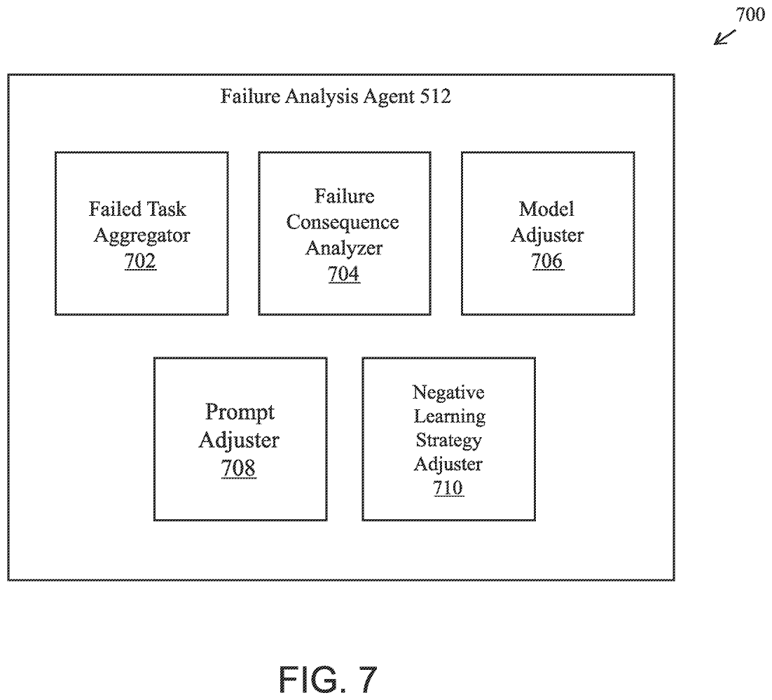

To this end, FIG. 7 illustrates an example architecture 700 for failure analysis agent 512, in various implementations. As shown, failure analysis agent 512 may include any or all of the following components: a failed task aggregator 702, a failure consequence analyzer 704, a model adjuster 706, a prompt adjuster 708, and/or a negative learning strategy adjuster 710. These components may be combined or omitted, as desired, in further implementations. In addition, while failure analysis agent 512 may be executed by a singular device (e.g., device 200), its components may also be executed in a distributed manner, in which case its executing devices may be viewed as a singular device for purposes of the teachings herein.

In various implementations, failed task aggregator 702 may be in charge of aggregating all tasks of troubleshooting agent 506 that failed. In some cases, failed task aggregator 702 may receive indications of the failed tasks from an evaluation framework for the self-healing system.

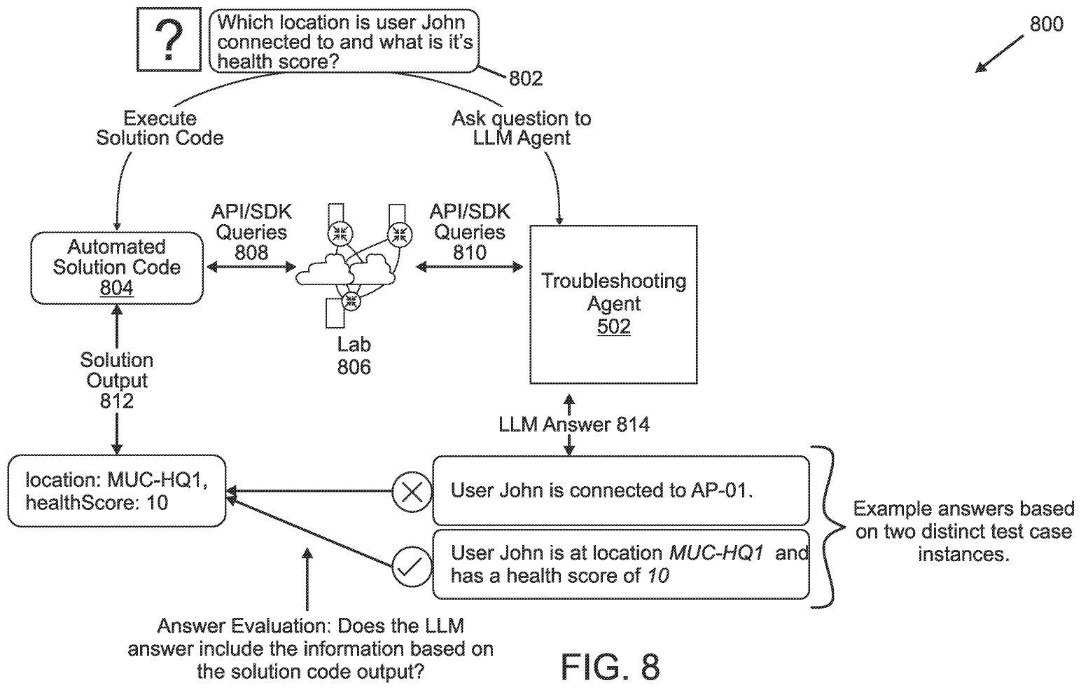

FIG. 8 illustrates an example performance valuation framework 800, in some implementations. As shown, the performance evaluation framework may operate by evaluating a question 802 from test libraries in two ways: 1.) by sending question 802 to troubleshooting agent 506 and 2.) by executing the automated solution code 804 associated with question 802 as part of its testcase.

In turn, troubleshooting agent 506 may attempt to answer question 802 by issuing API or SDK-based queries to one or more devices in the target network, thereby generating an LLM answer 814. Here, the network may take the form of a lab 806 or other test environment, although a live network could also be used, in some instances. Similarly, test libraries may also execute automated solution code 804 via API or SDK-based queries 808 to one or more devices in the target network, to generate a solution output 812.

To evaluate the performance of troubleshooting agent 506, it may then compare solution output 812 to LLM answer 814. In this case, for the answer to be considered correct, it must include the exact location and value of the health score. As shown, the location indicated by solution output 812 is “MUC-HQ1” with a health score of “10.” Thus, if LLM answer 814 indicates that John is connected to “AP-01,” it will have failed the evaluation, as it did not sufficiently answer question 802.

However, more complex evaluation scenarios demand special handling. For instance, evaluating whether troubleshooting agent 506 correctly answered a monitoring task (e.g.: Visualize the QoS drops on device muc-hq01-rt01, interface Gi0/0/1.) is significantly more challenging. In such cases, a dedicated assertion method is required to compare the underlining time series data used to build the graph. Although the LLM code and the automated solution code query the network simultaneous, slight time-related differences may occur. Therefore, when comparing the two answers, only the overlapping time interval should be considered.

The evaluation of other question types, such as those related to root causing network issues (e.g.: Can you help me figure out why John can't authenticate to the network?) present a different set of challenges. Like a human, troubleshooting agent 506 may employ many different strategies to troubleshoot the issue and formulate an answer. The LLM may also use different wording to formulate the answer making the evaluation much more difficult.

In some implementations, performance evaluation framework 800 may also conduct tests that include root-cause identification questions based on predefined scenarios executed against a network environment using a system such as a ‘troublemaker’ mechanism that instantiates an issue in the network and, as such, the root cause of the issue is known a priori. This allows the solution part of the testcase to be simplified to a logic block that confirms the existence of the root cause instead of going through all the troubleshooting steps.

Evaluating the LLM's answer in this context can then be accomplished using two methods. In one approach, the SME writing the test case defines a number of alternate acceptable answers against which the LLM answer can be compared, such examples of expected outputs of an LLM-based network troubleshooting and monitoring agent. As shown, troubleshooting agent 506 is expected to identify that John's authentication issues are related to a communication issue with the authentication, authorization, and accounting (AAA) server caused by packets being discarded by a firewall policy. Multiple syntactical variants of the answer are considered acceptable as long as they include key elements like the affected service name or IP address, the impact (drop, discard) and the point of failure (the firewall policy name).

In a second approach, performance evaluation framework 800 may employ an LLM to assess the equivalence between the root cause description, as provided by the scenario definition for the troublemaker, and the response generated by troubleshooting agent 506. This method offers greater flexibility and does not necessitate the manual definition of numerous alternate answers.

Performance evaluation framework 800 may then aggregate the evaluation results across all test cases that are part of the same evaluation session into metrics, such as any or all of the following below:

TABLE 1

| Metric | Definition | Interpretation |
|---|---|---|
| Efficacy | Fraction of test cases | Our main metric, which |
| | without error. | denotes the overall efficacy |
| | | of the agent on our |
| | | benchmark. |
| Token Efficiency | The number of tokens | A secondary metric that |
| | consumed by the agent | indicates whether the agent |
| | (averaged across runs). | uses token efficiently. |
| Median Response Time | The median response time | A secondary metric that |
| | across all questions. | indicates how fast the |
| | | responses are. This is an |
| | | important indicator for the |
| | | usability of the product. |
| Method Precision | The fraction of used | A secondary metric that |
| | methods that were | indicates how effective the |
| | expected (averaged across | agent is in using the API or |
| | runs) | SDK. It is penalized when |
| | | using extra methods. |
| Method Recall | The fraction of expected | A secondary metric that |
| | methods that were used | indicates whether the agent |
| | (averaged across runs) | discovered the strategy to |
| | | perform the task. Usually, |
| | | a partial recall leads to a |
| | | failure. |
| Code Reliability | The fraction of code | A secondary metric that |
| | executions that did not lead | indicates how reliable the |
| | to an exception (averaged | code produced by the agent |
| | across runs). | is. |
| Search Recall | The recall of the semantic | A troubleshooting metric |
| | search (averaged across | that evaluates the fraction |
| | runs). | of relevant methods |
| | | retrieved by the semantic |
| | | search. |
| Search Precision | The precision of the | A troubleshooting metric |
| | semantic search (averaged | that evaluates the fraction |
| | across runs). | of relevant methods among |
| | | the retrieved methods. |
| Search Accuracy | Fraction of test cases that | A troubleshooting metric |
| | had a recall of 1.0. | that evaluates whether all |
| | | the required methods are |
| | | retrieved by the semantic |
| | | search. |
| Error rate | Average number of errors | A secondary metric that |
| | per test case. | evaluates how frequently |
| | | errors arise. Note that this |
| | | is different from the |
| | | efficacy, as more than one |
| | | error can be raised per test |
| | | case. |
| Warning rate | Average number of | A secondary metric that |
| | warnings per test case. | evaluates how frequently |
| | | warnings arise. |
| Reproducibility | Fraction of runs with the | A metric that evaluates |
| | same outcome (either | how reproducible the test |
| | success or failure). | cases are. For instance, a |
| | | test case that succeeds or |
| | | fails 3 times out of 5 will |
| | | have a reproducibility of |
| | | 60%. The lower bound for |
| | | this metric is 50%, which |
| | | means it fails or succeeds |
| | | half of the time. |

In some implementations, the results of each evaluation may be stored by performance evaluation framework 800 in an AI/Ops tool, with both of commercial SaaS based services (e.g., Weights and Biases) and open-source solutions (Deepchecks, Grafana, etc.) stacks being readily available.

As shown, performance evaluation framework 800 may function as a “gamemaster” that is responsible for coordinating the instantiation and execution of new evaluation sessions, from here after called “games.” At the start of each game, the gamemaster performs several tasks such as any or all of the following:
LLM model selection and parameter configuration: for each new evaluation session, performance evaluation framework 800 may select the LLM model that should be used by troubleshooting agent 506 to answer the questions or combination of models in such cases where different models are used for different tasks (e.g., one LLM model for planning and a different LLM for code generation). This may also entail selecting configuration parameters, such as:
   model temperature which regulates the randomness, or creativity of the LLM model,
   maximum number of tokens consumed to answer a question,
   maximum number of steps allowed to be performed to answer a question,
   prompting strategy, should multiple ones be available.
Environment and scenario instantiation: before a ‘game’ can start, performance evaluation framework 800 may prepare a target network environment to be used by troubleshooting agent 506 to answer the questions. During this step, performance evaluation framework 800 can leverage a troublemaker system to instantiate one or more impairments on the target environment corresponding to specific troubleshooting scenarios (e.g., high WAN circuit latency, congestion, Wi-Fi network issues, authentication problems, etc.). Depending on the nature of the troublemaker scenario, performance evaluation framework 800 may be required to wait for a certain amount of time, required for the issue to be detected by the various network controllers and monitoring systems present in the target environment, before asking troubleshooting agent 506 to answer questions (troubleshoot).
Select a list of questions (test cases) for troubleshooting agent 506: performance evaluation framework 800 may query test libraries for the list of available test cases. The evaluation session may include all available questions or can be more specific towards a certain networking domain (DNAC, SD-WAN, ISE) or impairment scenario, for example, questions related to troubleshooting wireless authentication issues. In one embodiment, performance evaluation framework 800 may use the static test case tags (domain, issue category, scenario) to select the appropriate questions from test libraries while in another it may leverage other mechanisms such as semantic search of test libraries or employ an LLM to review the test cases from test libraries and extract the relevant items.

Finally, once the above tasks are completed, performance evaluation framework 800 may attempt to achieve several goals:
In one instance, performance evaluation framework 800 may evaluate and compare the performance of different LLM models (or combinations of LLM models) for network monitoring and troubleshooting tasks either in general or targeted on more specific domains, and categories of issues. In this case, the same set of questions is run against a list of LLM models of interest, and performance statistics are collected.
In another instance, performance evaluation framework 800 may help train LLM agents. In this second case, performance evaluation framework 800 may be responsible for executing large amounts of games (evaluation runs) that in turn result in an extensive collection of traces to be used in a reinforcement learning-based training process.
In yet another instance, a similar approach of generating large amounts of games can be used with the goal of compiling a database of reusable code snippets.

Finally, in some instances, language model process 249 may interface with user interface 514 to allow a system administrator to configure and monitor the behavior of performance evaluation framework 800 and the overall system. Using user interface 514, the administrator could schedule new evaluation sessions (games) and monitor the execution of such games closely. To this end, user interface 514 may use API integrations with an AIOps platform of choice to build summarized views of the evaluation results, however, a detailed review of the results may only be available in the AIOps platform itself.

Referring again to FIG. 7, in other embodiments, failed task aggregator 702 may instead obtain the list of tasks that troubleshooting agent 506 failed based on manual flagging by an expert user. Note that it may be desirable to trigger the negative learning process described herein only for some tasks, especially when the consequences of failure are high (but not only). To this end, on troubleshooting agent 506 completing a task as in FIG. 6, a user may provide feedback via user interface 514 regarding their level of satisfaction (e.g., whether the user considers the task a success or failure) and, optionally, whether failure of accomplishing the task is critical. For instance, assume that troubleshooting agent 506 returns the following answer 624 to user 602:

Answer: “The number of packets that were QoS dropped in the last 3 hours on the WAN router that John is connected to is 3.”

In such a case, the system may also include ability for user 602 to rate whether this answer is satisfactory or a failure, such as by clicking a “thumbs up” or “thumbs down” icon, or other suitable input.

In a further implementation, troubleshooting agent 506 itself may decide to interrupt the task, to seek expert feedback (guidance) or to simply stop the process because of a lack of confidence, thus leading to task failure.

In yet another embodiment, a static list of “common reasoning mistakes” may be stored and retrieved in a prompt thanks to experts. For example, such “recipes” could have the following form: “if you are planning to execute a troubleshooting task related to a user complaining about poor QoE for a voice application, do not try to execute the following sub-task: A, B, . . . ,” or “do not execute the following sequence of steps, . . . .”

In some cases, failed task aggregator 702 may use a policy to select the failed tasks that are candidates for negative learning. For example, the system administrator may decide that all tasks related to performance analysis are candidates, some tasks related to troubleshooting with minimum impact but all troubleshooting tasks leading to network configuration changes should be candidates for negative learning. Such policies may be based on the category of users impacted, list of applications, etc.

During execution, failure consequence analyzer 704 may determine the consequence of a failed task by troubleshooting agent 506 and assess the strength of the negative feedback signal sent to other components of the system, as described below. In other words, failure consequence analyzer 704 may seek to answer the question “how serious was the mistake?” The criticality of the failure may be specified by the designer of test cases of the evaluation platform (e.g., as shown in FIG. 8) in the form of a tag (critical, moderate, not-critical) or a scalar from 1 to 10 where 10 refers to a failure with strong consequences. The criticality may also be specified using custom user feedback.

In a second embodiment, failure consequence analyzer 704 may use a model to automatically assess the consequence of the mistake. For example, failure consequence analyzer 704 may train a classifier on a sampled dataset of past failures. Input features to the classifier may be the nature of the task, set of entities involved (e.g., number of users, number of devices, etc.), whether the task output leads to close loop control (e.g., generate a new network state via network re-configuration, etc.). Such information may be provided, for instance, by the label provided by the evaluation platform or user feedback.

In a further embodiment, failure consequence analyzer 704 may monitor the consequence of the actions triggered by a troubleshooting task. For example, if an automation process is triggered that performs changes in the network that results from a troubleshooting task by the system, failure consequence analyzer 704 may determine whether the issue has been solved or led to a worse situation, in which case the tasks did fail with potentially highly undesirable consequences.

In yet another embodiment, failure consequence analyzer 704 may adjust the strength of the negative signal based on the frequency of a specific mistake, as opposed to its criticality, or a combination of both. Indeed, LLMs suffer from a lack of predictability/reproducibility. Evaluation platforms may measure a reproducibility index used to determine whether a given task can be reproduced with a similar outcome. Failure consequence analyzer 704 may use the reproducibility metric to adjust the signal strength below. In such a case, the negative signal is amplified for tasks with a low reproducibility index. In some cases, as described below, the negative signal can also be used to adjust the prompt for a given task, as well, to indicate the set of steps that led to failure in the past.

Regardless of how failure consequence analyzer 704 quantifies the consequence of failure, it may then translate that consequence into a signal strength Sigstrength. The aim of Sigstrength is to reflect how critical is the failure of a given task. In one embodiment, failure consequence analyzer 704 may compute values using a static assignment from the test case designer. For example, if the aim of the task is to provide a trend or correlation, failure consequence analyzer 704 may set Sigstrength=low. On the other hand, if the aim of the task is to adjust the QoS on a high bandwidth link because traffic of high priority suffers from not-high enough priority, then failure consequence analyzer 704 may set Sigstrength=high (changing the configuration is likely to have a strong impact if not done correctly). Sigstrength could also take the form of a scalar, in further cases.

Model adjuster 706 may determine the most appropriate strategy to tune the model, to mitigate the risk of such a failure happening again (e.g., by unlearning knowledge that was used to trigger the mistake). One such approach may consist of unlearning by aligning the LLM, which is claimed to be much cheaper than aligning with pairwise samples (aka preference samples), using techniques such as Reinforcement Learning using Human Feedback (RLHF). The list of undesirable outcomes (failures) is the only dataset available (the list of positive outcomes—success tasks used to train the model is not available). The objective is to use gradient “Ascent” (instead of Gradient Descend) consisting of following the opposite direction of the gradient during training on the undesired token. In the context of the techniques herein, the next token is replaced by the label used for an undesirable sub-task that is known as leading to a task failure. Model adjuster 706 could use, for instance, tree of thoughts instead of token prediction, in further instances.

Another approach that model adjuster 706 could take consists in making use of mechanistic interpretability, the field of studying how to reverse engineer neural networks, which is a very active area of promising research. Here, the goal would be to identify the neural patterns leading to decisions prone to failed tasks. Yet another approach would be to rely on mono-semanticity where patterns (linear combinations) of neuron activations corresponding to given tasks are identified. Once a pattern is identified it becomes possible to “remove” such a pattern by accessing the model directly. Model adjuster 706 could then trigger a process consisting of repeating all failed tasks to determine if such failure no longer exists or at least happens less often (while not increasing the frequency of failure of other tasks since collateral damage may exist).

In other words, the primary idea here is that model adjuster 706 can exploit a negative signal (with strength Sigstrength) to modify the model either via retraining with Supervised Fine Tuning (SFT), unlearning, or removing undesirable patterns leading to task failures.

According to various implementations, prompt adjuster 708 is in charge of performing prompt adjustments using the negative signals, leveraging “negative” examples to be added to the prompt for similar tasks. Prompt adjuster 708 may use various strategies to do so. The simplest approach consists of elaborating a prompt containing a set of general instructions, augmented with relevant documents obtained using a retrieval augmented generation (RAG) approach. Then, prompt adjuster 708 could use Chain-of-Thought (CoT) where the approach explicitly requires the LLM to provide details about its thinking process to complete a given task. S elf-consistency with CoT may be used to send multiple requests to one or more LLMs and then using a voting strategy select the most popular chain of thoughts (without inspecting each thought/step in the chain). Thanks to In Context Learning (ICL), prompt adjuster 708 could augment prompts with examples on how to solve a task (n-shot learning). Here, prompt adjuster 708 could employ a custom list of negative CoT for tasks that the LLM failed to accomplish in the past and that are candidates for negative learning. For example, a negative sequence of steps might be: “When trying to troubleshoot an issue related to poor voice QoE experience by a user John, you tried the following set of tasks/thoughts: 1.) Determine John's IP address, 2.) Find the site John was connected to, 3.) Look at the number of applications used by John, . . . . Such a sequence of tasks did not allow to find the root cause of poor QoE.”

Prompt adjuster 708 could augment the negative example above by the signal strength: “When trying to troubleshoot an issue related to poor voice QoE experience by a user John, you tried the following CoT: 1.) Determine John's IP address, 2.) Find the site John was connected to, 3.) Look at the number of applications used by John, 4.) Suggest John to stop using Youtube while also making Voice calls. The suggested action did corrupt John's setup with bad consequences.” One strategy may consist of repeating the negative examples multiple times according to the strength value or adding explicit wording in the prompt to report the failure consequence.

In yet another embodiment, prompt adjuster 708 may (for negative examples) use another LLM to generate synthetic data with additional negative examples.

In another embodiment, prompt adjuster 708 may use a RAG strategy to select the list of negative examples may be determined using an embedding (and distance), in order to select ALL negative examples (failed tasks) that are close to the task at hand. Note that the prompt engineering and model tuning strategies are not mutually exclusive and may be used in conjunction with one another, in various implementations.

Finally, negative learning strategy adjuster 710 may evaluate the performance of the negative learning by the other components of failure analysis agent 512 and make adjustments to the strategy, as needed. As specified above, failure analysis agent 512 may perform a form of continuous learning using negative learning with adaptive signal strength. Since an LLM may be sometimes unpredictable it is imperative to monitor the effect of the negative signal, per class of tasks. In one embodiment, negative learning strategy adjuster 710 may monitor the percentage of failure per class of tasks and monitor whether negative learning leads to a positive trend (reduction of failure rate) while monitoring potential negative consequences (collateral damage on other tasks). In another embodiment, upon triggering new actions (e.g., modifying the prompt, retraining the model to unlearn), negative learning strategy adjuster 710 may systemically rerun the most recent set of failed tasks to assess whether the situation has improved. If the percentage of failure does not improve the signal strength may be dynamically adjusted for the class of task at hand or simply abandoned.

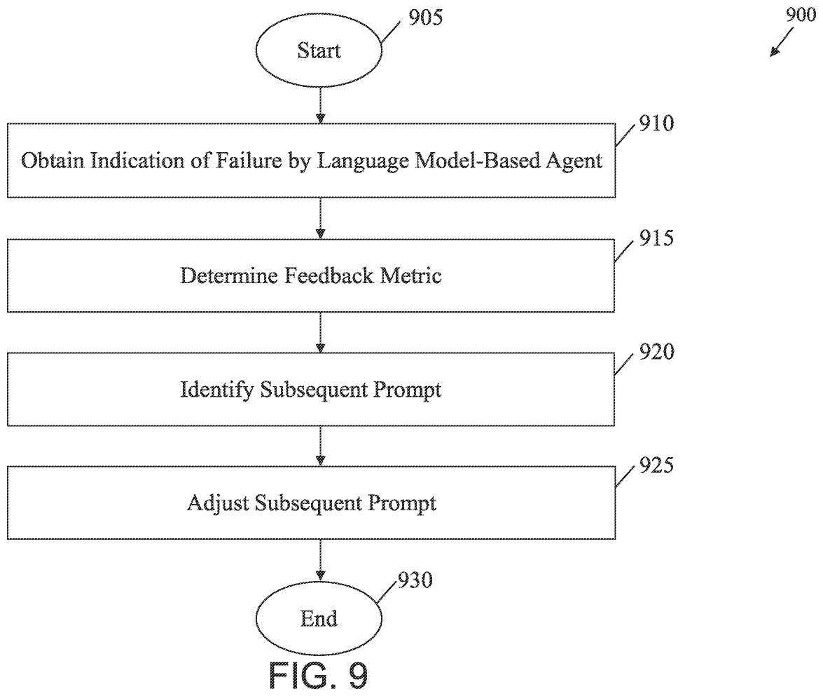

FIG. 9 illustrates an example simplified procedure (e.g., a method) for using negative feedback learning on a language model-based network troubleshooting agent, in accordance with one or more implementations described herein. For example, a non-generic, specifically configured device (e.g., device 200), such as a router, firewall, controller for a network (e.g., an SDN controller or other device in communication therewith), server, or the like, may perform procedure 900 by executing stored instructions (e.g., language model process 249 and/or network control process 248). The procedure 900 may start at step 905, and continues to step 910, where, as described in greater detail above, the device may obtain an indication of a failure by a language model-based agent for a computer network to perform a first task requested by a first prompt. In one implementation, the indication of the failure is based on user feedback regarding the first task. In other cases, the indication of the failure is generated by an evaluation framework for the language model-based agent that evaluates performance of the first task by the language model-based agent in a testing environment.

At step 915, as detailed above, the device may determine a feedback metric that quantifies how critical the failure is. In some instances, the feedback metric is based in part on how frequently the language model-based agent fails tasks of a similar type as the first task. In various implementations, the device may determine whether the failure is eligible to be used to adjust the subsequent prompt according to a defined policy. For instance, the defined policy is conditioned on an application or set of users associated with the first task. In one implementation, the device may also use the feedback metric to update the language model-based agent by unlearning knowledge it used to perform the first task.

At step 920, the device may identify a subsequent prompt for the language model-based agent to perform a new task of a similar type as the first task, as described in greater detail above. In some instances, the first task and the new task comprise troubleshooting a particular type of issue in the computer network.

At step 925, as detailed above, adjust, based on the feedback metric, the subsequent prompt to avoid the language model-based agent failing the new task. In some implementations, the device adjusts the subsequent prompt by indicating in the subsequent prompt that a particular set of chain-of-thought steps taken by the language model-based agent was not able to successfully perform the first task. In one implementation, the device may also repeat the particular set of chain-of-thought steps in the subsequent prompt based on the feedback metric.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for using negative feedback learning on a language model-based network troubleshooting agent, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, an indication of a failure by a language model-based agent for a computer network to perform a first task requested by a first prompt;
determining, by the device, a feedback metric that quantifies how critical the failure is;
identifying, by the device, a subsequent prompt for the language model-based agent to perform a new task of a similar type as the first task; and
adjusting, by the device and based on the feedback metric, the subsequent prompt to avoid the language model-based agent failing the new task.

2. The method as in claim 1, wherein the indication of the failure is based on user feedback regarding the first task.

3. The method as in claim 1, wherein the device adjusts the subsequent prompt by indicating in the subsequent prompt that a particular set of chain-of-thought steps taken by the language model-based agent was not able to successfully perform the first task.

4. The method as in claim 3, further comprising:
repeating the particular set of chain-of-thought steps in the subsequent prompt based on the feedback metric.

5. The method as in claim 1, wherein the first task and the new task comprise troubleshooting a particular type of issue in the computer network.

6. The method as in claim 1, wherein the indication of the failure is generated by an evaluation framework for the language model-based agent that evaluates performance of the first task by the language model-based agent in a testing environment.

7. The method as in claim 1, further comprising:
using, by the device, the feedback metric to update the language model-based agent by unlearning knowledge it used to perform the first task.

8. The method as in claim 1, wherein the feedback metric is based in part on how frequently the language model-based agent fails tasks of a similar type as the first task.

9. The method as in claim 1, further comprising:
determining, by the device, whether the failure is eligible to be used to adjust the subsequent prompt according to a defined policy.

10. The method as in claim 9, wherein the defined policy is conditioned on an application or set of users associated with the first task.

11. An apparatus, comprising:
one or more network interfaces;
a processor coupled to the one or more network interfaces and configured to execute one or more processes; and
a memory configured to store a process that is executable by the processor, the process when executed configured to:
obtain an indication of a failure by a language model-based agent for a computer network to perform a first task requested by a first prompt;
determine a feedback metric that quantifies how critical the failure is;
identify a subsequent prompt for the language model-based agent to perform a new task of a similar type as the first task; and
adjust, based on the feedback metric, the subsequent prompt to avoid the language model-based agent failing the new task.

12. The apparatus as in claim 11, wherein the indication of the failure is based on user feedback regarding the first task.

13. The apparatus as in claim 11, wherein the apparatus adjusts the subsequent prompt by indicating in the subsequent prompt that a particular set of chain-of-thought steps taken by the language model-based agent was not able to successfully perform the first task.

14. The apparatus as in claim 13, wherein the process when executed is further configured to:
repeat the particular set of chain-of-thought steps in the subsequent prompt based on the feedback metric.

15. The apparatus as in claim 11, wherein the first task and the new task comprise troubleshooting a particular type of issue in the computer network.

16. The apparatus as in claim 11, wherein the indication of the failure is generated by an evaluation framework for the language model-based agent that evaluates performance of the first task by the language model-based agent in a testing environment.

17. The apparatus as in claim 11, wherein the process when executed is further configured to:
use the feedback metric to update the language model-based agent by unlearning knowledge it used to perform the first task.

18. The apparatus as in claim 11, wherein the feedback metric is based in part on how frequently the language model-based agent fails tasks of a similar type as the first task.

19. The apparatus as in claim 11, wherein the process when executed is further configured to:
determine whether the failure is eligible to be used to adjust the subsequent prompt according to a defined policy.

20. A tangible, non-transitory, computer-readable medium storing program instructions that cause a device to execute a process comprising:
obtaining, by the device, an indication of a failure by a language model-based agent for a computer network to perform a first task requested by a first prompt;
determining, by the device, a feedback metric that quantifies how critical the failure is;
identifying, by the device, a subsequent prompt for the language model-based agent to perform a new task of a similar type as the first task; and
adjusting, by the device and based on the feedback metric, the subsequent prompt to avoid the language model-based agent failing the new task.
